(19) United States
(12) Patent Application Publication
(10) Pub. No.: US 2025/0007116 A1
(43) Pub. Date: Jan. 2, 2025

(54) ROLL CORE CONNECTING STRUCTURE OF BATTERY AND BATTERY

(71) Applicant: Trina Storage Solutions (Jiangsu) Co., Ltd, Changzhou (CN)

(72) Inventors: Zhiyi Jiang, Changzhou (CN); Fan Yang, Changzhou (CN); Lin Lu, Changzhou (CN); Siwei Wei, Changzhou (CN); Hongming Wang, Changzhou (CN)

(21) Appl. No.: 18/711,392

(22) PCT Filed: Nov. 18, 2022
(86) PCT No.: PCT/CN2022/132950

§ 371 Date: Aug. 12, 2024

(30) Foreign Application Priority Data
Nov. 19, 2021 (CN) 202122844921.4

(51) Int. Cl. H01M 50/533; H01M 10/04; H01M 50/536

(52) U.S. Cl. CPC H01M 50/533; H01M 10/0431; H01M 50/536

(57) ABSTRACT

The present disclosure relates to the technical field of power batteries, and discloses a roll core connecting structure of a battery and the battery. The battery comprises the roll core connecting structure of the battery; the roll core connecting structure of the battery comprises two roll cores, a first adapter, and a second adapter; the two roll cores are arranged in a first direction; two tabs having opposite polarities are arranged on an end face of each roll core in the first direction; the tabs are arranged in a second direction; in the first direction, the polarities of the two tabs located in the middle are the same, and the polarities of the two tabs located on two ends are the same; the first adapter is in a strip shape and extends in the second direction; the two tabs located in the middle are connected to the first adapter; the second adapter is in a U shape and annularly arranged on the first adapter; the two tabs located on the two ends are respectively connected to the second adapter; the first adapter and the second adapter are respectively configured to be connected to poles of the battery. According to the battery and the roll core connecting structure of the battery, the tabs have good overcurrent capability, and the whole structure is compact.

### TECHNICAL FIELD

The present disclosure mainly relates to the technical fields of power batteries, and in particular to a roll core connecting structure of a battery and the battery.

### BACKGROUND

With the support of the two trillion-level markets of electric vehicles and energy storage, lithium-ion batteries have attracted much attention from the downstream market. With the large-scale promotion of electric vehicles and energy storage products, people have higher demands on the charging speed of electric vehicles and the service life of energy storage products. The cycle life, dynamic performance and fast charging capability of lithium-ion batteries directly affect the charging speed and service life of the terminal, and determine the quality of the product. These performance indicators will be affected by the temperature rise and internal resistance of the battery roll core.

As shown in FIG. 1, the roll core of the battery is usually in a rectangular parallelepiped structure, in which the X direction indicates the width direction of the roll core, the Y direction indicates the thickness direction of the roll core, and the Z direction indicates the length direction of the roll core, The roll core 1′ is provided with positive tab and negative tab 2′ on the side surface in the width-thickness direction thereof, and the two tabs 2′ are arranged at intervals along the width direction of the roll core 1′. The positive tabs of two adjacent roll cores 1′ make electrical connection through an adapter and then are connected to the positive pole on the battery end cover, and the two negative tabs make electrical connection through an adapter and then are connected to the negative pole on the battery end cover. For the tabs, since the thickness of the pole piece is fixed, the thickness of the tabs is usually fixed, and when the width is wider, the cross-sectional area is larger, the corresponding internal resistance is smaller, the heat loss is less, and the current capacity is better. However, the width of the tabs is greatly limited when the two tabs are arranged along the width direction of the roll core.

Therefore, a roll core connecting structure of a battery and the battery are urgently needed to solve the above problems.

### SUMMARY

One purpose of the present disclosure is to provide a roll core connecting structure of a battery with good tab current carrying capacity and compact overall structure.

Another purpose of the present disclosure is to provide a battery which has a small internal resistance, a compact structure and a high capacity density by setting the above-mentioned roll core connecting structure.

To achieve this goal, this disclosure adopts the following technical solutions:

A roll core connecting structure of a battery, comprising:
two roll cores arranged in a first direction, wherein two tabs having opposite polarities are arranged on an end face of each roll core in the first direction, wherein the tabs are arranged in a second direction, and in the first direction, polarities of the two tabs located in the middle are the same, polarities of the two tabs located on two ends are the same;
a first adapter in a strip shape and extending in the second direction, and the two tabs located in the middle are connected to the first adapter;
a second adapter in a U shape and annularly arranged on the first adapter, and the two tabs located on the two ends are respectively connected to the second adapter;
wherein the first adapter and the second adapter are respectively configured to be connected to poles of the battery.

As an optional solution, wherein a size of the roll core in the second direction is greater than a size in the first direction.

As an optional solution, wherein the tabs located in the middle are first tabs, the first tab is in a V-shaped structure and includes a first connecting part and a first bending part connected to each other, the first connecting part is connected to the roll core, and the first bending part is arranged in a close fit with and connected to the first adapter;
the tabs located on the two ends are second tabs, the second tab is in a V-shaped structure and includes a second connecting part and a second bending part connected to each other, the second connecting part is connected to the roll core, and the second bending part is arranged in a close fit with and connected to the second adapter.

As an optional solution, wherein an opening side of the first tab and an opening side of the second tab on the same roll core are arranged opposite to each other.

As an optional solution, wherein the first bending part is closely connected to a side of the first adapter facing toward the roll core, and the second bending part is closely connected to a side of the second adapter facing away from the roll core.

As an optional solution, wherein the first bending part is connected to the first adapter by welding, and the second bending part is connected to the second adapter by welding.

As an optional solution, wherein the second adapter comprises:
a base portion extending in the first direction, and the base portion is used to connect to the poles of the battery;
two extension portions respectively connected to two ends of the base portion, wherein the extension portions extend in the second direction, each extension portion is correspondingly connected to one of the tabs, and a width W of the base portion is greater than a width B of the extension portions.

As an optional solution, wherein in the second direction, a first end of the first adapter extends out of an annularly arranged range of the second adapter, and the first end is used to connect to the poles of the battery.

As an optional solution, wherein the first adapter and the second adapter are symmetrically arranged to a straight line extending in the second direction.

A battery, comprising a shell, an end cover and above-mentioned a roll core connecting structure of the battery, wherein the roll core connecting structure of the battery is arranged inside the shell, the end cover can seal the shell, a first pole and a second pole are arranged on the end cover, the first adapter is connected to the first pole, and the second adapter is connected to the second pole.

As an optional solution, wherein the first pole is connected to the first adapter by welding, and the second pole is connected to the second adapter by welding.

The beneficial effects of this disclosure are:

In the roll core connecting structure of the battery of the present disclosure, the two roll cores are arranged along the first direction, and the two tabs on the roll core are also arranged along the first direction, that is, the two tabs complement each other in the second direction, so each tab can be set to a larger size along the second direction, so that the cross-section area of the tab is increased, thereby improving the current flow capacity of the tab and reducing heat loss. Through the first adapter in a strip shape and the second adapter in a U shape, the tabs with the same polarity on the two roll cores can be conveniently electrically connected respectively, and then electrically connected to the positive and negative poles of the battery respectively, satisfying the setting mode that the positive and negative tabs of the roll core extend from the same side of the roll core, making the connection structure of the battery roll core more compact.

The battery of the present disclosure has a small internal resistance, a compact structure and a high capacity density by providing the above-mentioned battery roll core connecting structure.

### BRIEF DESCRIPTION OF THE DRAWINGS

The features and properties of the present disclosure are further described by the following embodiments and the drawings.

FIG. 1 is a schematic view of the structure of a roll core and a tab provided by the prior art;

FIG. 2 is a front view of a roll core connecting structure provided in a specific embodiment of the present disclosure;

FIG. 3 is a top view of a roll core connecting structure provided in a specific embodiment of the present disclosure;

FIG. 4 is a cross-sectional view taken along line A-A in FIG. 3.

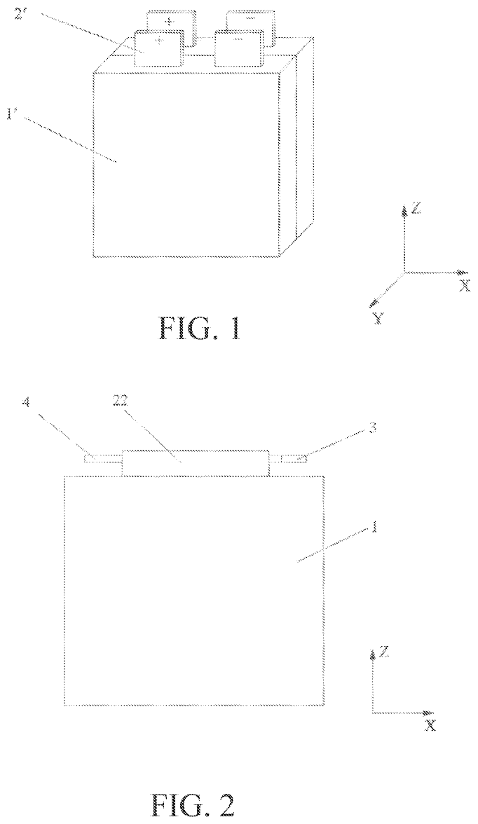

In the drawings:
1′—roll core; 2—′tab;
1—roll core;
21—first tab; 211—first connecting part; 212—first bending part; 22—second tab; 222—second bending part;
3—first adapter; 31—first end;
4—second adapter; 41—base portion; 42—extension portion.

### PREFERRED EMBODIMENT OF THE PRESENT DISCLOSURE

The present disclosure will be further described in detail below in conjunction with the drawings and embodiments. It is to be understood that the specific embodiments described herein are only used to explain the present disclosure, rather than to limit the present disclosure. It should also be noted that, for ease of description, only the parts related to the present disclosure, rather than all structures, are shown in the drawings.

In the description of this disclosure, unless otherwise clearly specified and limited, the terms “interconnected”, “connected”, and “fixed” should be understood in a broad sense, for example, it can be a fixed connection, a detachable connection, or an integral connection; it can be a mechanical connection or an electrical connection; it can be a direct connection or an indirect connection through an intermediate medium, it can be the internal connection of two elements or the interaction relationship between two elements. For ordinary technicians in this field, the specific meanings of the above terms in this disclosure can be understood according to specific circumstances.

In the present disclosure, unless otherwise clearly specified and limited, a first feature being “above” or “below” a second feature may include that the first and second features are in direct contact, or may include that the first and second features are not in direct contact but are in contact through another feature between them. Moreover, a first feature being “above”, “front” and “on” a second feature includes that the first feature is directly above and obliquely above the second feature, or simply indicates that the first feature is higher in level than the second feature. A first feature being “below”, “down” and “behind” a second feature includes that the first feature is directly below and obliquely below the second feature, or simply indicates that the first feature is lower in level than the second feature.

In the description of this embodiment, the terms “upper”, “lower”, “right”, etc., are based on the directions or positions shown in the drawings, and are only for the convenience of description and simplification of operation, rather than indicating or implying that the device or element referred to must have a specific direction, be constructed and operated in a specific direction, and therefore cannot be understood as limiting the present disclosure. In addition, the terms “first” and “second” are only used to distinguish in the description and have no special meaning.

The present embodiment provides a roll core connecting structure and a battery, the battery comprises a shell, an end cover and a roll core connecting structure, one end of the shell has an opening, the roll core connecting structure of the battery is arranged inside the shell, the end cover can seal the shell, a first pole and a second pole are arranged on the end cover. As shown in FIG. 2˜FIG. 4, the roll core connecting structure includes two roll cores 1, a first adapter 3, and a second adapter 4, wherein the Y direction in the drawing represents the first direction, which is also the thickness direction of the roll core 1. The X direction represents the second direction, which is also the width direction of the roll core 1, and the Z direction represents the length direction of the roll core 1, and the size of the roll core 1 in the length direction>the size in the width direction>the size in the thickness direction, the two roll cores 1 are arranged along the thickness direction (i.e., the Y direction) of the roll core 1. Each roll core 1 has two tabs with opposite polarities arranged along the thickness direction on the end face in the width-thickness direction. The tabs are arranged along the width direction of the roll core 1, and along the thickness direction of the roll core 1, the two tabs in the middle have the same polarity, and the two tabs at the two ends have the same polarity. In this embodiment, the two tabs in the middle are the first tabs 21, and the two tabs at the two ends are the second tabs 22, and if the first tab 21 is a positive pole, then the second tab 22 is a negative pole; if the first tab 21 is a negative pole, the second tab 22 is a positive pole. The first adapter 3 is in a strip shape and extends along the width direction of the roll core 1, the two first tabs 21 are connected to the first adapter 3. The second adapter 4 is in a U shape and is annularly arranged on the first adapter 3. Specifically, the second adapter 4 includes a base portion 41 and two extension portions 42, the base portion 41 extends along the thickness direction of the roll core 1, wherein the two extension portions 42 are connected to the two ends of the base portion 41 respectively, the extension portions 42 extend along the width direction of the roll core 1, and each extension portion 42 is connected to a corresponding tab. The first adapter 3 is connected to the first pole, and the base portion 41 of the second adapter 4 is connected to the second pole. It should be noted that the connection here means realizing both mechanical connection and electrical connection.

In the roll core connecting structure of the battery of this embodiment, the two tabs are arranged along the width direction of the roll core 1, so each tab can be set to a larger size along the width direction of the roll core 1, so that the cross-section area of the tab is increased, thereby improving the current flow capacity of the tab and reducing heat loss. The first adapter 3 arranged in a strip shape and the second adapter 4 arranged in a U shape can conveniently electrically connect the tabs with the same polarity on the two roll cores 1, and then electrically connect to the first pole and the second pole of the battery respectively, so as to satisfy the setting mode that the positive and negative tabs of the roll core 1 extend from the same side of the roll core 1, making the connecting structure of roll core 1 more compact. The battery of this embodiment has a small internal resistance, a compact structure and a high energy density by setting the above-mentioned battery roll core connecting structure.

In this embodiment, the first pole is welded to the first adapter 3, and the second pole is welded to the second adapter 4. Specific welding process parameters can be selected and set according to the size and material of the pole and the tab, and are not limited here.

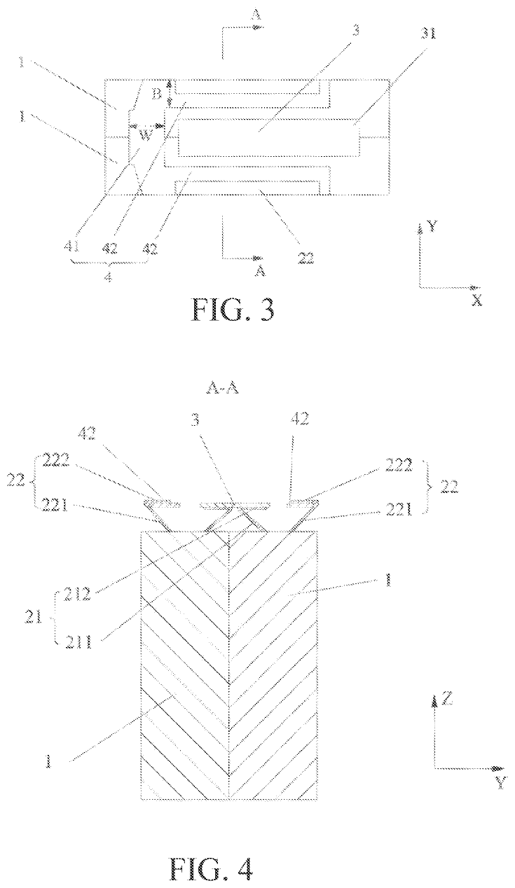

Preferably, as shown in FIG. 3, the first tab 21 and the second tab 22 are symmetrically arranged about a line along the width direction of the roll core 1, and correspondingly, the first adapter 3 and the second adapter 4 are also symmetrically arranged about a line along the width direction of the roll core 1. Since the first pole and the second pole are usually arranged at intervals on the midline of the end cover extending in the width direction, the first adapter 3 and the second adapter 4 are arranged in a symmetrical structure to facilitate their connection with the first pole and the second pole respectively.

Preferably, as shown in FIG. 3, the width W of the base portion 41 is greater than the width B of the extension portion 42, setting the width of the extension portion 42 to be narrower can prevent the extension portion 42 from contacting the first adapter 3, setting the width of the base portion 41 to be larger can ensure that there is sufficient area for connection with the second pole.

Furthermore, as shown in FIG. 3, along the width direction of the roll core 1, the first end 31 of the first adapter 3 is used to connect to the first pole of the battery, and the first end 31 of the first adapter 3 extends out of the annularly arranged range of the second adapter 4, so that a certain distance is maintained between the first end 31 and the second adapter 4, thereby preventing a short circuit between the first pole and the second adapter 4.

Preferably, as shown in FIG. 3 and FIG. 4, the first pole 21 has a V-shaped structure and includes a first connecting part 211 and a first bending part 212 connected to each other, the first connecting part 211 is connected to the roll core 1, the first bending part 212 is fitted and connected to the first adapter 3, and the fitting of the first bending part 212 and the first adapter 3 can ensure the reliability of the connection between the two. Similarly, the second tab 22 has a V-shaped structure and includes a second connecting part 221 and a second bending part 222 connected to each other, the second connecting part 221 is connected to the roll core 1, and the second bending part 222 is arranged and connected to the second adapter 4. The second bending part 222 is arranged to be attached to the second adapter 4 to ensure the reliability of the connection between the two. In this embodiment, the first bending part 212 is welded to the first adapter 3, and the second bending part 222 is welded to the extension portion 42 of the second adapter 4, the specific welding process parameters can be selected and set according to the materials of the tabs and the adapter plates, etc., and are not limited here.

Preferably, as shown in FIG. 4, the V-shaped structure opening side of the first tab 21 and the V-shaped structure opening side of the second tab 22 on the same roll core 1 are arranged opposite to each other, so that the two tabs with opposite polarities extend away from each other, thereby preventing the problem of short circuit between the two tabs of the roll core 1.

Furthermore, as shown in FIG. 4, the first bending part 212 is attached to the side of the first adapter 3 facing the roll core 1, and the second bending part 222 is attached to the side of the second adapter 4 facing away from the roll core 1, thereby further isolating the two tabs with opposite polarities to prevent a short circuit caused by the welding process. It should be noted that since the second bending part 222 of the second tab 22 is located on the side of the second adapter 4 away from the roll core 1, that is, toward the end cover of the battery, in order to ensure that the first adapter 3 and the second adapter 4 are respectively connected to the first pole and the second pole, then the first pole and the second pole can be selected to be arranged to protrude from the end cover toward the side close to the roll core 1, so as to be connected to the first end 31 of the first adapter 3 and the base portion 41 of the second adapter 4. In other embodiments, the first adapter 3 can also be configured as a structure in which the first end 31 is bent and tilted toward the side close to the end cover, in order to contact and connect with the first pole; the second adapter 4 can be configured as: the base portion 41 is bent and tilted toward the side close to the end cover to the extension portion 42 to achieve contact and connection with the second pole.

Obviously, the above embodiments of the present disclosure are only examples for clearly explaining the present disclosure, and are not intended to limit the embodiments of the present disclosure. For ordinary technicians in the field, according to the ideas of the present disclosure, there will be changes in the specific embodiments and disclosure scopes, and the content of this specification should not be understood as limiting the present disclosure. Any modifications, equivalent substitutions, and improvements made within the spirit and principles of the present disclosure shall be included in the protection scope of the claims of the present disclosure.

1. A roll core connecting structure of a battery, comprising:
two roll cores (1) arranged in a first direction, wherein two tabs having opposite polarities are arranged on an end face of each roll core in the first direction, wherein the tabs are arranged in a second direction, and in the first direction, polarities of the two tabs located in the middle are the same, polarities of the two tabs located on two ends are the same;
a first adapter (3) in a strip shape and extending in the second direction, and the two tabs located in the middle are connected to the first adapter (3);
a second adapter (4) in a U shape and annularly arranged on the first adapter (3), and the two tabs located on the two ends are respectively connected to the second adapter (4);
wherein the first adapter (3) and the second adapter (4) are respectively configured to be connected to poles of the battery.

2. The roll core connecting structure of the battery of claim 1, wherein a size of the roll core (1) in the second direction is greater than a size in the first direction.

3. The roll core connecting structure of the battery of claim 1,
wherein the tabs located in the middle are first tabs (21), the first tab (21) is in a V-shaped structure and includes a first connecting part (211) and a first bending part (212) connected to each other, the first connecting part (211) is connected to the roll core (1), and the first bending part (212) is arranged in a close fit with and connected to the first adapter (3);
the tabs located on the two ends are second tabs (22), the second tab (22) is in a V-shaped structure and includes a second connecting part (221) and a second bending part (222) connected to each other, the second connecting part (221) is connected to the roll core (1), and the second bending part (222) is arranged in a close fit with and connected to the second adapter (4).

4. The roll core connecting structure of the battery of claim 3, wherein an opening side of the first tab (21) and an opening side of the second tab (22) on the same roll core (1) are arranged opposite to each other.

5. The roll core connecting structure of the battery of claim 3, wherein the first bending part (212) is closely connected to a side of the first adapter (3) facing toward the roll core (1), and the second bending part (222) is closely connected to a side of the second adapter (4) facing away from the roll core (1).

6. The roll core connecting structure of the battery of claim 3, wherein the first bending part (212) is connected to the first adapter (3) by welding, and the second bending part (222) is connected to the second adapter (4) by welding.

7. The roll core connecting structure of the battery of claim 1, wherein the second adapter (4) comprises:
a base portion (41) extending in the first direction, and the base portion (41) is used to connect to the poles of the battery;
two extension portions (42) respectively connected to two ends of the base portion (41), wherein the extension portions (42) extend in the second direction, each extension portion (42) is correspondingly connected to one of the tabs, and a width W of the base portion (41) is greater than a width B of the extension portions (42).

8. The roll core connecting structure of the battery of claim 1, wherein in the second direction, a first end (31) of the first adapter (3) extends out of an annularly arranged range of the second adapter (4), and the first end (31) is used to connect to the poles of the battery.

9. The roll core connecting structure of the battery of claim 1, wherein the first adapter (3) and the second adapter (4) are symmetrically arranged to a straight line extending in the second direction.

10. A battery, comprising a shell, an end cover and a roll core connecting structure of the battery of claim 1, wherein the roll core connecting structure of the battery is arranged inside the shell, the end cover can seal the shell, a first pole and a second pole are arranged on the end cover, the first adapter (3) is connected to the first pole, and the second adapter (4) is connected to the second pole.

11. The battery of claim 10, wherein the first pole is connected to the first adapter (3) by welding, and the second pole is connected to the second adapter (4) by welding.
